(19) United States
(12) Patent Application Publication
(10) Pub. No.: US 2022/0358595 A1
(43) Pub. Date: Nov. 10, 2022

(54) Non-Discriminatory and Non-Individualized Vehicle Insurance Pricing Methodology Using Advanced Data Collection and Analytics

(71) Applicant: In the Car, LLC, Stamford, CT (US)

(72) Inventor: Mitchel May, Hewlett, NY (US)

(21) Appl. No.: 17/302,648

(22) Filed: May 9, 2021

(51) Int. Cl. G06Q 40/08; G06Q 30/06; G06Q 50/26; G06Q 30/02; G06F 17/18

(52) U.S. Cl. CPC G06Q 40/08; G06Q 30/0645; G06Q 50/26; G06Q 30/0205; G06F 17/18

(57) ABSTRACT

The present invention is directed to a non-discriminatory and non-individualized macro data-based method for determining vehicle insurance pricing and applying such pricing to incentivize vehicle sales, lease, rentals, and/or subscriptions programs.

### CROSS-REFERENCE TO RELATED APPLICATIONS

The following applications and any continuations thereof are herein expressly incorporated by reference: U.S. application Ser. No. 09/645,020 filed Aug. 23, 2000, and U.S. patent application Ser. No. 11/776,502 filed on Jul. 11, 2007 (now issued as U.S. Pat. No. 7,801,750), and U.S. patent application Ser. No. 12/890,517 filed Sep. 24, 2010, all entitled “Insurance Incentive Program for Promoting the Purchase or Lease of an Automobile”; U.S. patent application Ser. No. 09/645,794 (now U.S. Pat. No. 7,349,860) filed on Aug. 24, 2000, and U.S. patent application Ser. No. 11/776,512 7 Jul. 11, 2007, both entitled “Insurance Incentive Program Having A Term Of Years For Promoting The Purchase Or Lease Of An Automobile”; U.S. patent application Ser. No. 09/645,795 filed on Aug. 24, 2000 (now issued as U.S. Pat. No. 7,831,466), U.S. patent application Ser. No. 11/776,507 filed on Jul. 11, 2007 (now issued as U.S. Pat. No. 7,949,556), U.S. patent application Ser. No. 13/049,134 filed on Mar. 16, 2011 (now issued as U.S. Pat. No. 8,321,245), U.S. patent application Ser. No. 14/206,990 filed on Mar. 12, 2014, entitled “Apparatuses, Methods and Systems for Insurance Incentive Program for Promoting the Purchase or Lease of a Vehicle” and U.S. patent application Ser. No. 13/049,134 filed on Mar. 16, 2011; and U.S. patent application Ser. No. 16/949,413 filed on Oct. 28, 2020 entitled “Method for Improving the Environment by Providing Incentives for Purchase, Lease, re-Lease, Rental or Subscription of Environmentally Friendly Zero Emission, Low Emission and Battery Electric Vehicles”.

### FIELD OF THE INVENTION

The present invention is directed to a non-discriminatory and non-individualized macro data-based method for determining vehicle insurance pricing and applying such pricing to incentivize vehicle sales, lease, rentals, and/or subscriptions programs.

### BACKGROUND OF THE INVENTION

It is common for manufacturers, or retailers to provide incentives to potential purchasers, lessees or renters in order to increase the sale, lease, rental and/or subscription of an item. Particularly with respect to the sale or lease of automobiles, manufacturers have offered lowered interest rates on financing, rebates and extended warranties in an attempt to increase sale or lease of one or more classes of automobile. Throughout this specification, the term “vehicle” or “vehicles” includes Sports Utility Vehicles (SUV's), light trucks, hybrids, all-electric vehicles, scooters, electric scooters, golf carts, other miscellaneous vehicles, all hydrogen-powered vehicles, drones, airframes, etc. and furthermore includes self-driving, semi-autonomous and autonomous vehicles.

One typical problem faced by purchasers, lessees, subscribers, or renters of automobiles, in particular, is obtaining insurance for the vehicle at the time of sale, lease, rental, or subscription. The consumer must typically complete many forms to obtain the insurance. Such a process may deter the consumer from completing the sale, lease or rental. Furthermore, the characteristics of the consumer, such as the age, sex, marital status, area of residence, vehicle usage, the number of drivers living with the consumer and the make and model of the car purchased are all considered by an insurance provider to determine a rate for an insurance premium for the insurance policy sought. The cost of the insurance policy may be prohibitive, thereby impacting sale or lease of that class of automobile. The problem is particularly acute in the emerging vehicle sharing and vehicle subscription services. The problem appears to be equally acute in the emerging Electric Vehicle (EV) and semi-autonomous vehicle market where high insurance prices based on individualized data basically price out minorities from these markets. Public policy dictates that EV's should be encouraged in urban areas due to the lack of emissions, thereby leading to better air quality and less noise. Therefore, incorporating insurance costs into the prices for these services on a non-individualized basis can significantly enhance the attractiveness of these programs and the ability of minorities to obtain these vehicles.

Virtually all insurance companies calculate insurance prices by compiling an ever more intrusive and individualized set of data on prospective customers. This method of calculating insurance prices is inherently discriminatory by its very nature because it penalizes a driver who lives in poorer neighborhoods, which often contain large numbers of minorities who are struggling to seize the American dream. Included in the individualized data are the following: age, education, location of residence, driving record, medical record, citizenship status, criminal record, employment status, marital status, financial status, employment status, etc. This method of more intrusive collection of individualized data often has no correlation to how safely the individual in question will drive the vehicle. For example, a conviction for marijuana possession several years prior will have little correlation to how a driver with small children and rent to pay will drive his or her car. The bottom line is that drivers who can least afford high insurance premiums are the ones who are required to pay these high insurance premiums. The societal impact of such discriminatory individualized pricing is contrary to public policy. Higher insurance premiums result in fewer minority drivers being able to afford a vehicle and the associated insurance. This leads to fewer minorities being able to drive to jobs and schools outside of their neighborhoods and/or more uninsured drivers. The insurance companies use all this individualized data to determine the individualized price for each policyholder. In an era when privacy and discrimination are becoming more and more important, allowing insurance companies to obtain and use such individualized data is contrary to public policy.

The present invention presents an alternative to the ever more intrusive individualized insurance policy methodology by disclosing an insurance pricing methodology based on macro data. This is accomplished by accumulating macro data from primary and secondary sources, analyzing such data and calculating non-individualized insurance prices based on such analysis. In essence, the instant invention seeks to democratize vehicle insurance pricing and end the discriminatory individualized insurance pricing that is disproportionately applied to minorities and the disadvantaged.

### SUMMARY OF THE INVENTION

The present application is directed to particular features of a system and method of calculating insurance pricing based on aggregation and analysis of macro insurance data. The process is initiated by accumulating data via a secure network or a series of secure networks utilizing state of the art encryption technology from one or more broad categories of sources, including but not limited to: (1) primary data from OEM's, auto rental companies, subscription companies, etc, and/or (2) third party data including data from the various federal and state transportation and insurance departments, and/or (3) geographic and demographic data from the federal and state government as well as academic studies, and/or (4) other primary data from insurance and vehicle sales, rental, and leasing companies as well as other sources that may become available in the future. Some or all of the foregoing macro data is fed into the Data Store that is the input for the proprietary method that the applicant has developed to calculate vehicle insurance pricing. This method combines processor-based programs, algorithms, analysis, artificial intelligence and experience-based heuristic professional input to calculate pricing that in general should be lower than the prices currently generated. As an example, the proprietary method analyzes the macro loss data for all Ford F-150 buyers and lessees and develops a macro average price without regard to the individualized characteristics that current insurance pricing methodologies rely on (e.g. age, medical condition, education, FICO credit scores, geographic areas, etc.)

The system and method inherent in the present invention has the additional benefit of providing data privacy to individuals. In an era when privacy is becoming more and more important, the present invention protects the data of the individual by using only macro data to arrive at optimum insurance pricing.

A further benefit of the instant invention is that it is anti-discriminatory. By relying on macro data, there is virtually no opportunity to discriminate on race, gender, where you live, non-vehicle related criminal record, religion, medical condition, etc. None of the foregoing individualized data has a correlation to how safely an individual will drive a vehicle.

### DESCRIPTION OF THE PRIOR ART

There are countless examples of methods for calculating vehicle insurance premiums in the prior art. Most of these examples comprise obtaining more and more individual information from vehicle operators in order to fine tune individual insurance premiums. As such most of the prior art is irrelevant to the instant invention.

### BRIEF DESCRIPTION OF THE DRAWINGS

Further aspects of the instant invention will be more readily appreciated upon review of the detailed description of the preferred embodiments included below when taken in conjunction with the accompanying drawings, of which:

FIG. 1 is an overview of the system and process inherent in the applicant's macro method for calculating vehicle insurance prices;

### DETAILED DESCRIPTION OF THE INVENTION

For ease in interpreting the innovative concepts embodied in this application, the following acronyms are presented:

ITCM—In The Car Module

MBIP—Macro Based Insurance Premium

MBIPP—Macro Based Insurance Premium Program

NIMBP—Non-Individualized Macro Based Premiums

OEM— Original Equipment Manufacturer

According to various embodiments of the present invention, a system and method for calculating insurance prices based on aggregation and analysis of macro data is disclosed. As used herein, the terms “sale,” “sell,” “selling,” “sold,” “buy,” “buying,” “rent,” “rental,” “lease,” “subscribe,” or “subscription,” refer to any of a purchase of an item, a purchase of an item with financing or a lease, rental or subscription of an item. The item may be a product produced by a manufacturer, or any product or service offered for sale or lease by a retailer. Whether the item is purchased, leased, or rented the purchaser, renter, or lessee shall be uniformly referred to herein as a “buyer” or “customer.” Similarly, the purchase, sale, lease, rental or subscription of an item may be referred to in the aggregate as a “conveyance”.

For ease in understanding the present invention, the example of a lease, rental, lease, subscription, or purchase of an automobile is explained in detail. However, the same methodology applies to virtually any type of land, maritime, or airborne vehicle. In preferred embodiments, the item that is sold is an automobile of a particular make and model. The automobile may be new or used as those terms are understood by one of ordinary skill in the art.

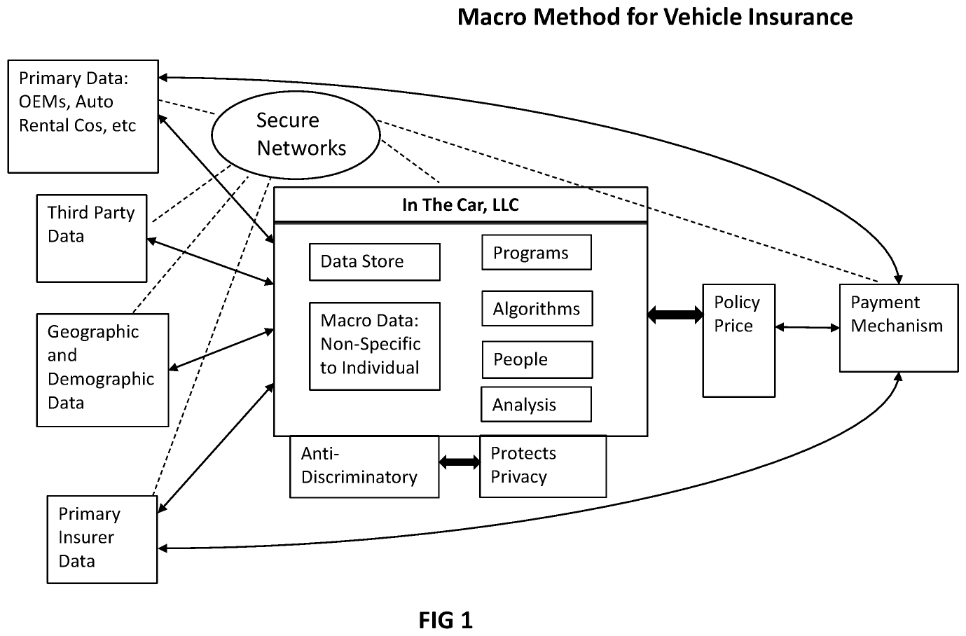

The overall advantages of the systems and methods of the present invention over prior programs are exemplified in FIG. 1. Primary data from some or all of the OEMs, Auto Rental Companies, subscription companies, dealers, etc., along with Third Party Data, Geographic and Demographic Data, and/or Primary Insurer Data are all fed into the proprietary In the Car premium calculation module.

The external data is deposited in the Data Store portion of the In the Car Module. The Module makes use of a variety of proprietary programs, algorithms, and input from key people such as data scientists, and analysts to derive Non-Individualized Macro Based Premiums. The data analysis will comprise artificial intelligence coupled with the latest probabilistic and statistical models and methods to result in a Macro Based Premium. While all or most of the data analysis and pricing calculations will be performed digitally, the output and some of the input will be reviewed by an experienced insurance professional to ensure that the data and the calculations make sense. A final step in the program is review of the data, calculations and premiums by management.

A payment mechanism is employed to ensure Primary Insurers receive the premiums.

A feedback mechanism ensures that Primary Data and Primary Insurer Data is updated to reflect the results of the Macro Based Insurance Premium implementation.

There are two ancillary benefits of the Macro Based Insurance Premium program inherent in the In The Car Module (ITCM). This program is anti-discriminatory in its implementation. Since Macro data is used to arrive at premiums, there is virtually no chance that insureds will be discriminated against. The premiums are the same for broad groups of drivers.

A second major benefit is that in a world where the privacy of consumers is compromised almost daily, use of Macro data protects the insured's privacy. The instant methodology does not collect the ever more intrusive types of data that the insurance industry currently collects. Items such as gender, income level, education, occupation, non-driving criminal record, marital status, etc are not collected using this Macro method. Since these types of data are not collected, they can not be compromised and the consumer's privacy is ensured. This instant method only collects information on vehicle type and claims in a given region. The consumer's individualized data is not collected and is therefore protected.

The output from the ITCM and associated process is that a consumer is issued a policy that is priced on Macro non-individualized data analyzed by the ITCM. The consumer may pay the insurer directly or the cost of the insurance may be included in the total lease, purchase, subscription or rental price that is charged by the OEM or leasing, subscription or rental company. The ITCM ensures that whichever method for payment of insurance is selected that the appropriate arrangements for payment of the insurance costs are made. The only thing the consumer has to do is provide proof of residency in the geographic region. In general, the geographic regions will be no smaller than a county or township. Often the geographic region will encompass several counties, townships, cities, and/or towns and combinations thereof.

The ITCM as exemplified in the instant invention should result in lower administrative costs for insurers since less time and effort will be expended collecting and analyzing a plethora of individualized data and then devising premium rates that will be accepted by regulators. Furthermore, regulators should readily accept the instant methodology because it serves the dual public policy imperatives of being non-discriminatory and protective of consumers' privacy. The overall impact of this methodology should be to increase sales/leases/subscriptions because heretofore disadvantaged persons who were excluded from the marketplace due to asymmetric insurance pricing now will be in the market. In addition, costs to insurers should decrease and the overall economy should prosper as more people will be able to get to work.

While the ITCM applies primarily to vehicle insurance, the same non-individualized macro data methodology may be used for other types of insurance.

The present methodology contains an audit function that will be accessible to regulators to ensure that the non-discriminatory and privacy protection aspects of the instant invention are maintained and are practiced.

Although the invention has been described in detail in the foregoing embodiments, it is to be understood that the descriptions have been provided for purposes of illustration only and that other variations both in form and detail can be made thereupon by those skilled in the art without departing from the spirit and scope of the invention, which is defined solely by the appended claims.

The following is claimed:

1. A processor implemented non-discriminatory and privacy protecting methodology for calculating vehicle insurance premiums for a class of vehicles utilizing non-individualized macro data from one or more of the following sources:
a. primary data from OEM's, auto rental companies, subscription companies, leasing companies, etc;
b. third party data including data from the various federal and state transportation and insurance departments;
c. geographic and demographic data from the federal and state government as well as academic studies; and/or
d. other primary data from insurance and vehicle sales, rental, and leasing companies, industry groups as well as other sources that may become available in the future.

2. The methodology as in claim 1 where the non-individualized macro data is aggregated, collected, analyzed and processed over secure networks and servers.

3. The methodology as in claim 1 where the output is a non-individualized insurance premium and policy for a given type of vehicle in a geographic region.

4. A methodology as in claim 1 where consumer privacy is ensured by not collecting individualized data such as race, gender, marital status, occupation, education, age, non-driving criminal record, etc.

5. A methodology as in claim 1 where a policy premium price is calculated and a method to ensure timely payment to the primary insurer is included.

6. A methodology as in claim 1 where the anti-discriminatory and privacy protection attributes are complimentary.

7. A methodology as in claim 1 where the barrier of high insurance premiums is removed for minority and disadvantaged drivers.

8. An apparatus for providing a non-discriminatory and privacy protecting vehicle insurance transaction incentive comprising:
a. a processor; and
b. a memory in electrical communication with the processor, the memory for storing a plurality of processing instructions for enabling the processor to:
i. calculate a non-discriminatory and privacy protecting macro based insurance premium;
ii. issue a macro-based insurance policy upon a consumer providing proof of residency in a given geographic region.

9. An apparatus as in claim 8 where all data transfer, analysis, processing and calculations are performed over secure networks using encrypted technology.

10. An apparatus as in claim 8 where the insurer is paid the macro based insurance premium.

11. An apparatus as in claim 8 where the cost of the insurance premium may be included in the total periodic price of the purchase, lease, subscription or rental of a vehicle.

12. An apparatus as in claim 8 where at least one of the following sources of macro data are accessed and processed over secure networks using secure processors:
a. primary data from OEM's, auto rental companies, subscription companies, leasing companies, etc;
b. third party data including data from the various federal and state transportation and insurance departments;
c. geographic and demographic data from the federal and state government as well as academic studies;
d. industry groups; and/or
e. other primary data from insurance and vehicle sales, rental, and leasing companies, industry groups as well as other sources that may become available in the future.

13. A method for increasing the sales, subscriptions, rentals, or leases of vehicles by providing a non-discriminatory and privacy protecting macro based insurance premium and policy based on access, analysis, statistical and probabilistic analysis of government, industry, OEM, dealer, and insurance macro data.

14. A method as in claim 13 where no individualized data is collected, analyzed, retained, or processed.

15. A method as in claim 13 where artificial intelligence is combined with statistical and probabilistic models to calculate the macro based premium.
